(19) United States
(12) Patent Application Publication
(10) Pub. No.: US 2024/0163527 A1
(43) Pub. Date: May 16, 2024

(54) VIDEO GENERATION METHOD AND APPARATUS, COMPUTER DEVICE, AND STORAGE MEDIUM

(71) Applicant: Douyin Vision Co., Ltd., Beijing (CN)

(72) Inventors: Qiang YU, Beijing (CN); Zaojun HUANG, Beijing (CN); Yong TANG, Beijing (CN)

(21) Appl. No.: 18/506,596

(22) Filed: Nov. 10, 2023

(30) Foreign Application Priority Data
Nov. 10, 2022 (CN) 202211409819.4

(51) Int. Cl. H04N 21/81; G06T 13/20; G06T 19/00; G06V 10/44

(52) U.S. Cl. CPC H04N 21/816; G06T 13/20; G06T 19/006; G06V 10/44

(57) ABSTRACT

The present disclosure provides a video generation method and apparatus, computer device, and storage medium, wherein the method comprises: generating a virtual three-dimensional scene, the virtual three-dimensional scene including at least one target object; in response to performing an event editing operation on the target object, generating an event stream corresponding to the target object, the event stream including: event information respectively corresponding to a plurality of nodes, wherein the event information is determined based on the event editing operation and is used for describing an event action executed by the target object; controlling the target object to execute an event action corresponding to the event information in the virtual three-dimensional scene based on the event information respectively corresponding to the plurality of nodes in the event stream, and acquiring a first target video of the target object when controlling the target object to execute the event action.

### CROSS-REFERENCE TO RELATED APPLICATIONS

The present application claims the benefit of priority to the Chinese patent application No. 202211409819.4 filed with Chinese Patent Office on Nov. 10, 2022, which is hereby incorporated by reference in its entirety into the present application.

### TECHNICAL FIELD

The present disclosure relates to a technical field of computer image processing, and specifically, to a video generation method and apparatus, a computer device, and a storage medium.

### BACKGROUND

At present, a plurality of professional software often needs to be involved in production of a section of 3D animation. For example, Maya, 3Dmax and the like are adopted for animation of a 3D model, katana and Maya are adopted for light rendering, nuke, Premiere Pro and the like are adopted for editing and synthesizing, so that the process of producing a section of 3D animation is too complicated. It is costly for a user to learn and master the professional software, which makes it difficult for the user to finish a section of 3D animation alone.

### SUMMARY

The embodiment of the present disclosure at least provides a video generation method and apparatus, a computer device, and a storage medium.

In a first aspect, an embodiment of the present disclosure provides a video generation method, comprising:
generating a virtual three-dimensional scene, the virtual three-dimensional scene including at least one target object;
in response to performing an event editing operation on the target object, generating an event stream corresponding to the target object, the event stream including: event information respectively corresponding to a plurality of nodes, wherein the event information is determined based on the event editing operation and is used for describing an event action executed by the target object;
controlling the target object to execute an event action corresponding to the event information in the virtual three-dimensional scene based on the event information respectively corresponding to the plurality of nodes in the event stream, and acquiring a first target video of the target object when controlling the target object to execute the event action.

In an optional implementation, the method further comprises:
acquiring a second target video of a real scene;
performing a fusion process on the first target video and the second target video to obtain a target video including the target object and the real scene.

In an optional implementation, the generating a virtual three-dimensional scene includes:
generating a virtual three-dimensional space corresponding to the virtual three-dimensional scene;
determining a coordinate value of at least one target object in the virtual three-dimensional space;
based on the coordinate value of the target object in the virtual three-dimensional space, adding a three-dimensional model corresponding to the target object into the virtual three-dimensional space to form the virtual three-dimensional scene;
in an optional implementation, the method further comprises:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

In an optional implementation, the performing an event editing operation on the target object includes:
generating the node, and receiving a basic event material corresponding to the generated node;
based on the basic event material, generating event information corresponding to the generated node.

In an optional implementation, the node includes a time node, and the generating the node includes:
determining an event execution time on a time axis, and based on the event execution time, generating a time node corresponding to the event execution time.

In an optional implementation, the controlling the target object to execute a corresponding event action in the virtual three-dimensional scene based on the event stream includes:
with respect to each time node in the event stream, controlling the target object to execute an event action corresponding to the time node in the virtual three-dimensional scene;
in response to not reaching a next time node corresponding to the time node after completion of executing the event action corresponding to the time node, repeatedly executing an event action corresponding to the time node.

In an optional implementation, the node includes an event node, and the controlling the target object to execute the corresponding event action in the virtual three-dimensional scene based on the event stream includes:
with respect to each event node in the event stream, controlling the target object to execute an event action corresponding to the event node in the virtual three-dimensional scene, and after completion of executing the event action corresponding to the event node, executing an event action corresponding to a next event node.

In an optional implementation, the target object includes a plurality of target objects, and the controlling the target object to execute an event action corresponding to the event information in the virtual three-dimensional scene based on the event information respectively corresponding to the plurality of nodes in the event stream includes:
based on an event execution time of a plurality of nodes of the event streams respectively associated with a plurality of target objects, performing a merging operation on event information in the event streams respectively associated with the plurality of target objects to obtain an event execution script;
based on the event execution script, controlling the plurality of target objects to execute event actions respectively corresponding to the plurality of target objects in the virtual three-dimensional scene.

In a second aspect, an embodiment of the present disclosure further provides a video generation apparatus, comprising:
a first generation module for generating a virtual three-dimensional scene, the virtual three-dimensional scene including at least one target object;
a second generation module for generating, in response to performing an event editing operation on the target object, an event stream corresponding to the target object, the event stream including event information respectively corresponding to a plurality of nodes, wherein the event information is determined based on the event editing operation and is used for describing an event action executed by the target object;
a first acquisition module for controlling the target object to execute an event action corresponding to the event information in the virtual three-dimensional scene based on the event information respectively corresponding to the plurality of nodes in the event stream, and acquiring a first target video of the target object when controlling the target object to execute the event action.

In an optional implementation, the apparatus further comprises a second acquisition module for:
acquiring a second target video of a real scene;
performing a fusion process on the first target video and the second target video to obtain a target video including the target object and the real scene.

In an optional implementation, the first generation module is further used for:
generating a virtual three-dimensional space corresponding to the virtual three-dimensional scene;
determining a coordinate value of at least one target object in the virtual three-dimensional space;
based on the coordinate value of the target object in the virtual three-dimensional space, adding a three-dimensional model corresponding to the target object into the virtual three-dimensional space to form the virtual three-dimensional scene.

In an optional implementation, the apparatus further comprises a third generating module for:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

In an alternative implementation, when an editing operation is performed on the target object, the second generation module is further used for:
generating the node, and receiving a basic event material corresponding to the generated node;
based on the basic event material, generating event information corresponding to the generated node.

In an optional implementation, the second generation module is further used for:
determining an event execution time on a time axis, and based on the event execution time, generating a time node corresponding to the event execution time.

In an optional implementation, when controlling the target object to execute a corresponding event action in the virtual three-dimensional scene based on the event stream, the second generation module is used for:
with respect to each time node in the event stream, controlling the target object to execute an event action corresponding to the time node in the virtual three-dimensional scene;
in response to not reaching a next time node corresponding to the time node after completion of executing the event action corresponding to the time node, repeatedly executing an event action corresponding to the time node.

In an optional implementation, when controlling the target object to execute the corresponding event action in the virtual three-dimensional scene based on the event stream, the second generation module is further used for:
with respect to each event node in the event stream, controlling the target object to execute an event action corresponding to the event node in the virtual three-dimensional scene, and after completion of executing the event action corresponding to the event node, executing an event action corresponding to a next event node;
In an optional implementation, when controlling the target object to execute an event action corresponding to the event information in the virtual three-dimensional scene based on the event information respectively corresponding to a plurality of nodes in the event stream, the second generation module is used for:
based on an event execution time of a plurality of nodes of the event stream respectively associated with a plurality of target objects, performing a merging operation on event information in the event stream respectively associated with the plurality of target objects to obtain an event execution script;
based on the event execution script, controlling the plurality of target objects to execute event actions respectively corresponding to the plurality of target objects in the virtual three-dimensional scene.

In a third aspect, an optional implementation of the present disclosure further provides a computer device comprising a processor, and a memory. The memory stores machine readable instructions executable by the processor, and the processor is used for executing the machine readable instructions stored in the memory. The machine readable instructions, when executed by the processor, execute the steps of the above-mentioned first aspect or any one of possible implementations in the first aspect.

Ina fourth aspect, an optional implementation of the present disclosure further provides a computer readable storage medium, on which a computer program is stored, the computer program, when being performed, executing the steps of the above-mentioned first aspect or any one of possible implementations in the first aspect.

The video generation method provided by the embodiment of the present disclosure determines, in response to performing an event editing operation on the target object, an event stream composed of event information respectively corresponding to a plurality of nodes, and uses the event stream to automatically control the target object to execute an event action to obtain a first target video, thus reducing the difficulty in video generation.

In addition, when performing the event editing operation, it is possible to change positions of the nodes in the event stream by controlling respective nodes in the event stream, so as to adjust timing for the target object executing an event action corresponding to the event information, thus realizing edition on order and time for executing the event actions; by means of various event editing operations, it is possible to generate event information corresponding to the event editing operation, so as to realize edition on the content executed by the event action; and by means of acquiring a first target video of the target object when the target object executing an event action, it is possible to realize the output of the 3D animation, so as to complete the production of the 3D animation in a one-stop mode, thus reducing the difficulty in producing the 3D animation.

In order to make the aforementioned objects, features and advantages of the present disclosure more comprehensible, preferred embodiments accompanied with figures are described in detail below.

### BRIEF DESCRIPTION OF THE DRAWINGS

In order to more clearly illustrate the technical solutions of the embodiments of the present disclosure, the drawings required in the embodiments will be briefly described below, and the drawings herein incorporated in and forming a part of the specification illustrate embodiments consistent with the present disclosure and, together with the description, serve to explain the technical solutions of the present disclosure. It should be understood that the following drawings depict only certain embodiments of the present disclosure and are therefore not to be considered as limiting of its scope. For those skilled in the art, additional related drawings may be derived from these drawings without inventive effort.

FIG. 1 illustrates a flow diagram of a video generation method provided by some embodiments of the present disclosure;

FIG. 2 illustrates an example diagram of adding an animation provided by some embodiments of the present disclosure;

FIG. 3a illustrates a first example diagrams of performing an event editing operation on a target object provided by some embodiments of the present disclosure;

FIG. 3b illustrates a second example diagram of performing an event editing operation on a target object provided by some embodiments of the present disclosure;

FIG. 4 illustrates an example diagram of performing a merging operation on a general time axis provided by some embodiments of the present disclosure;

FIG. 5 illustrates a flow diagram of another video generation method provided by some embodiments of the present disclosure;

FIG. 6 shows a schematic diagram of a video generation apparatus provided by some embodiments of the present disclosure;

FIG. 7 shows a schematic diagram of a computer device provided by some embodiments of the present disclosure.

### DETAILED DESCRIPTION

To make the objects, technical solutions and advantages of the embodiments of the present disclosure clearer, the technical solutions in the embodiments of the present disclosure will be described clearly and completely with reference to the drawings in the embodiments of the present disclosure. It is obvious that the described embodiments are only a part of the embodiments of the present disclosure, not all of the embodiments. The components of the embodiments of the present disclosure, as generally described and illustrated herein, can be arranged and designed in a wide variety of different configurations. Thus, the following detailed description of the embodiments of the present disclosure is not intended to limit the scope of the present disclosure as claimed, but is merely representative of selected embodiments of the present disclosure. All other embodiments, which can be derived by those skilled in the art from the embodiments of the present disclosure without making any inventive effort, shall fall within the protection scope of the present disclosure.

Research shows that production of a section of 3D animation needs at least three steps: step 1, production, mapping, material and the like of a 3D model; step 2, adding narrative interactive elements such as actions, speaking, scene light, camera movement special effects of a 3D model and the like; step 3, adjusting cooperation of the actions and speaking of the 3D model with scene light and camera movement special effects; and finally generating the 3D animation.

At present, a plurality of professional software often needs to be involved in production of a section of 3D animation. For example, Maya, 3Dmax and the like are adopted for animation of a 3D model, katana and Maya are adopted for light rendering, nuke, Premiere Pro and the like are adopted for editing and synthesizing, so that the process of producing a section of 3D animation is too complicated, and it is costly for a user to learn and master the professional software, which makes it difficult for the user to finish a section of 3D animation alone.

Based on the above research, the present disclosure provides a video generation method, which determines, in response to performing an event editing operation on a target object, an event stream composed of event information respectively corresponding to a plurality of nodes, and uses the event stream to automatically control the target object to execute an event action to obtain a first target video, thereby reducing the difficulty in video generation.

The drawbacks with respect to the above solution are all the results obtained by the inventor through practice and careful research. Therefore, the discovery process of the above problem and the solution proposed by the present disclosure below with respect to the above problem should be the contribution made by the inventor to the present disclosure in the course of making the present disclosure.

It should be noted that, similar reference numbers and letters represent similar items in the following figures. Thus, once some item is defined in one figure, it does not need to be further defined or explained in subsequent figures.

To facilitate understanding of the present embodiment, firstly, a video generation method disclosed in the embodiments of the present disclosure is described in detail. An execution subject of the video generation method provided by the embodiments of the present disclosure is generally a computer device with certain computing capability. The computer device includes, for example, a terminal device, a server or other processing device, where the terminal device can be a User Equipment (UE), a mobile device, a user terminal, a terminal, a cellular phone, a cordless phone, a Personal Digital Assistant (PDA), a handheld device, a computing device, a vehicle-mounted device, a wearable device, and the like. In some possible implementations, the video generation method can be implemented by a processor invoking computer readable instructions stored in a memory.

A video generation method provided by the embodiments of the present disclosure is described below.

Referring to FIG. 1, a flow diagram of a video generation method provided by the embodiment of the present disclosure is shown. The method comprises steps S101 to S103, wherein,
S101: generating a virtual three-dimensional scene, the virtual three-dimensional scene including at least one target object;
S102: in response to performing an event editing operation on the target object, generating an event stream corresponding to the target object, the event stream including event information respectively corresponding to a plurality of nodes, wherein the event information is determined based on the event editing operation and is used for describing an event action performed by the target object;
S103: controlling the target object to execute an event action corresponding to the event information in the virtual three-dimensional scene based on the event information respectively corresponding to the plurality of nodes in the event stream, and acquiring a first target video of the target object when controlling the target object to execute the event action.

The above steps of the present disclosure are described, respectively, in detail below.

With respect to the above step S101, the virtual three-dimensional scene can be, for example, a virtual scene generated by computer technologies. The virtual three-dimensional scene is presented on a screen of a computer based on the shooting view angle of a virtual camera, and the virtual three-dimensional scenes under different view angles can be obtained by changing the shooting view angle of the virtual camera. The virtual three-dimensional scene includes at least one target object, and the target object can be, for example, a virtual role such as a virtual character or animal or the like, or a virtual article such as a hat, a weapon, a scroll, a tree, a vegetation or the like, which is controlled by a user and presented in the virtual three-dimensional scene.

Besides, it can also be a virtual light source, a virtual camera or the like which presents the scene special effects in the virtual three-dimensional scene. Generally speaking, the virtual light source and the virtual camera are visible to the user in a course of editing the event stream, and are invisible to the user when entering a special effect preview stage after the editing is finished.

In one embodiment provided by the present disclosure, generating a virtual three-dimensional scene can include, for example: generating a virtual three-dimensional space corresponding to the virtual three-dimensional scene; determining a coordinate value of the at least one target object in the virtual three-dimensional space; and based on the coordinate value of the target object in the virtual three-dimensional space, adding a three-dimensional model corresponding to the target object into the virtual three-dimensional space to form the virtual three-dimensional scene.

Here, the virtual three-dimensional space includes a three-dimensional coordinate system, any coordinate position on the three-dimensional coordinate system corresponds to a coordinate value thereof, and any coordinate value on the three-dimensional coordinate system can be mapped to a corresponding spatial position in the virtual three-dimensional scene.

illustratively, the coordinate value of the target object in the virtual three-dimensional space can be determined according to a final position the target object stays in the virtual three-dimensional space as controlled by the user. For example, a user selects a target object from a resource library outside the virtual three-dimensional space, drags it to the virtual three-dimensional space, and a coordinate value of the target object in the virtual three-dimensional space is determined according to the final position the target object stays in the virtual three-dimensional space. The final position is represented here as a position of the target object in the virtual three-dimensional space when the user triggers a releasing operation.

In another embodiment provided by the present disclosure, in response to an adding operation of adding the target object into the virtual three-dimensional scene, determining an initial feature of the target object in the virtual three-dimensional scene; adding a three-dimensional model corresponding to the target object into the virtual three-dimensional scene based on the initial feature.

Illustratively, when a target object is added into a virtual three-dimensional scene, an initial feature option can pop up in a display interface of a computer. The initial feature option includes function options such as adjusting an initial pose, an initial animation, an initial light and shadow type and an initial lens view angle of the target object. Each of these function options can have a default setting, and the user can adjust the default setting or accept the default setting.

For example, when the user places a target object at any position in the virtual three-dimensional scene, an initial position thereof can be determined. At this time, the user can adjust an initial orientation of the target object in the initial pose function option, and in turn determine the initial pose of the target object in the virtual scene.

Here, when the target object is a virtual role, a face orientation of the virtual role can be specified as a basis for orientation adjustment to determine the initial orientation of the virtual role; when the target object is a virtual article, a front surface of the virtual article can be specified as a basis for orientation adjustment to determine the initial orientation of the virtual article.

In addition, when the user selects to accept the default setting, the target object will be added into the virtual three-dimensional scene at a preset initial pose.

As another example, an initial animation of the target object is determined in the initial animation function option.

Here, when the target object is a virtual role, an initial animation such as waving, smiling, blinking, or the like can be added to the virtual role; and when the target object is a virtual vegetation, an initial animation of swinging with the wind can be added thereto.

In addition, when the user selects to accept the default setting, the target object will be added to the virtual three-dimensional scene in a preset initial animation. The preset initial animation can be set to be animation-free, that is, the target object does not make any action, or is set according to the actual situation.

For another example, when the target object is a virtual light source which is added to the virtual three-dimensional scene, an initial light and shadow type of the virtual three-dimensional scene can be determined in the initial light and shadow type function option. The initial light and shadow type includes, for example, scene light, ambient light, and etc.

For another example, when the target object is a virtual role, an initial lens view angle can be determined in the initial lens view angle function option. The initial lens view angle includes, for example, facial close-up, full body close-up, panoramic view angle, and the like.

With respect to the step S102, performing an event editing operation on the target object can include editing at least one event of an action, an animation, a language, a light and shadow special effect, and a camera movement special effect on the target object.

In one embodiment provided by the present disclosure, the node is generated according to performing an event editing operation on the target object, and a basic event material corresponding to the generated node is received; and based on the basic event material, event information corresponding to the generated node is generated.

Here, the node can be represented as a mark of a piece of event information. The event stream of the target object is composed of the event information respectively corresponding to the plurality of nodes. The basic event material can be represented as a content of a piece of event information, such as at least one of the following: a set of actions, a section of voice, a section of light and shadow special effects, a section of camera movement special effects and the like.

Illustratively, a target object can be added to the resource library, as well as a set of actions, a section of voice, a section of light and shadow special effects, and so on. The resource library can be preset by a software developer, or can be uploaded by a resource publisher onto a target application carrying the present method through other model production software, for example, 3D MAX modeling. The resource library includes: resources of actions, expressions, role models, special effects such as light and shadow, sound and the like.

The resource publisher includes the user himself or herself and other users. The produced resources such as sound, light and shadow special effects, models, animations and the like are uploaded onto a resource server, through which the user acquires a resource list and downloads related resources. Here, if the resource is produced by the user himself or herself, the resource can be directly imported into the target application for his or her own use; if the user wants to share the resource with other users, the user can also select to upload the resource to the resource server.

Illustratively, a virtual role is added to a role resource library of a virtual three-dimensional scene, and an event editing operation is performed on the virtual role to generate a node. An event editing stage is entered, during which, the event editing operation is to control the virtual role to move a distance in the virtual three-dimensional scene. Specifically, a target position is determined in the virtual three-dimensional scene, and after the target position is determined, a special effect preview stage is entered, and the virtual role moves from the current position to the target position. At this time, the virtual role moving from the current position to the target position is received, and a basic event material is generated.

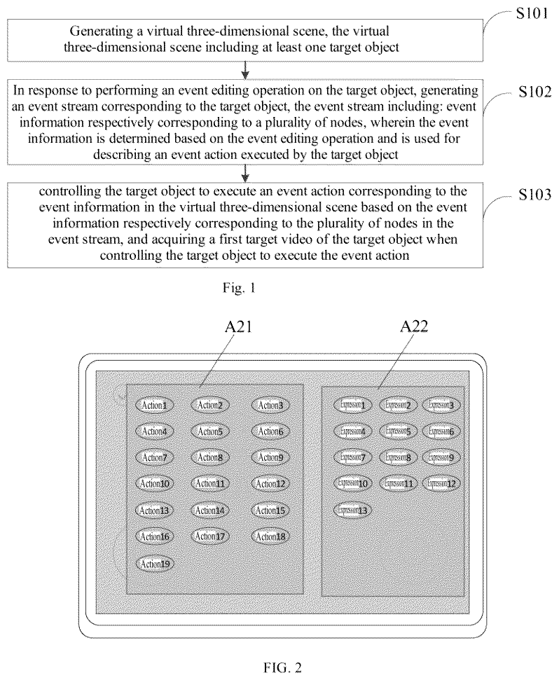

For another example, an example diagram of adding animation as shown in FIG. 2 is referred to. In FIG. 2, when an event editing operation is to add a section of actions and facial expressions to the virtual role, an action resource library A21 and an expression resource library A22 are loaded into the virtual three-dimensional scene. A user can select corresponding actions from the action resource library A21, and select expressions with respect to changes in facial features of the virtual role from the expression resource library A22. After the actions and the expressions of the virtual role are determined, a special effect preview node is entered, in which the virtual role performs the actions and the expressions. At this time, the action changes and the expression changes of the virtual role are received and a basic event material is generated.

For another example, the event editing operation is to control the virtual camera to shoot around the virtual role. Specifically, a virtual camera is generated in the virtual three-dimensional scene, and then the user can drag the virtual camera to determine its shooting track. A special effect preview stage is entered, in which the virtual three-dimensional scene is switched to the view angle of the virtual camera generated in the virtual three-dimensional scene that moves along the shooting track. At this time, a display picture of the virtual three-dimensional scene shot by the virtual camera in accordance with the shooting track is received and a basic event material is generated.

Here, it should be noted that, in the event editing stage, the virtual camera is located outside a virtual three-dimensional scene to shoot the virtual three-dimensional scene, and a user can control a display picture of the virtual three-dimensional scene by controlling a button or sliding a screen. When the user needs to add a camera movement special effect, a virtual camera is added to the virtual three-dimensional scene. By dragging the virtual camera and controlling the display picture of the virtual three-dimensional scene in cooperation with the control button, the user can determine a shooting track of the virtual camera. When the special effect preview stage is entered, the display picture of the virtual three-dimensional scene is displayed in accordance with the shooting track of the virtual camera added to the virtual three-dimensional scene.

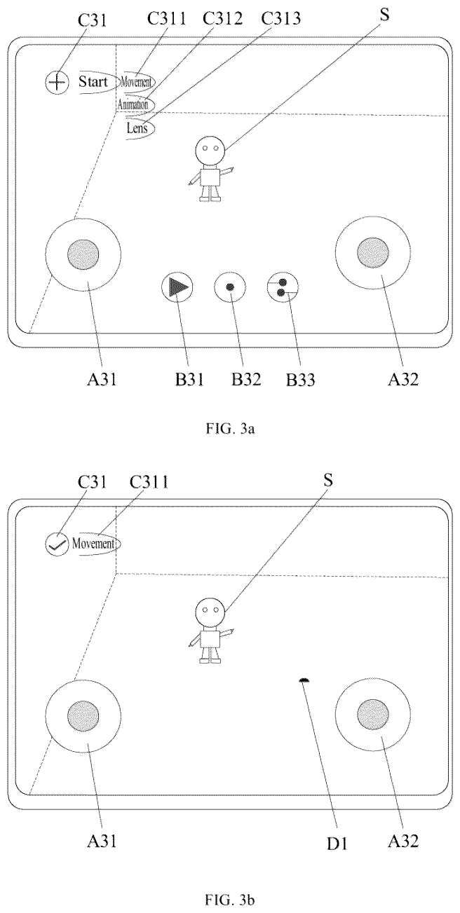

In one possible implementation, a first example diagram of performing an event editing operation on a target object as shown in FIG. 3a is referred to. FIG. 3a includes a virtual scene and a plurality of controls. The virtual scene includes a virtual role S. The plurality of controls include a rocker A31 and a rocker A32 for controlling a lens view angle of a virtual camera in an event editing phase, a preview control B31 for entering a special effect preview phase, an output video control B32 for generating a first target video, an option control B33 for setting, e.g. a time and order for performing events corresponding to each node or the like, and an event editing control C31 for generating a node and performing an event editing operation on the virtual role S in the event editing phase. The user clicks the event editing control C31 to make three sub controls pop up, namely, a movement sub control C311 for editing movement of the virtual role S, an animation sub control C312 for editing the animation executed by the virtual role S, and a lens sub control C313 for editing the lens angle, respectively. The user clicks any one of the sub controls to generate a node corresponding to the sub control, and enters an event editing stage. A second example diagram of performing an event editing operation on a target object is shown in FIG. 3b. The user clicks the movement sub control C311 to generate a moving node, and enters the event editing stage. At this time, the preview control B31, the output video control B32 and the option control B33 in the virtual three-dimensional scene are hidden, and the user can realize zoom-in, zoom-out, left lateral movement, and right lateral movement of the lens view angle by dragging the rocker A31, and realize upward-rotation, downward-rotation, leftward-rotation, and rightward-rotation of the lens view angle by dragging the rocker A32, so as to change the display picture of the virtual three-dimensional scene. The user determines a target position D1 in the virtual three-dimensional scene through a clicking operation for indicating a position to which the virtual role S moves when entering the special effect preview stage. Here, after determining the one or more target positions, the user clicks the event editing control C31 again to end the event editing phase. At this time, the user can enter the special effect preview stage by clicking the preview control B31. At this time, the virtual role S will receive and generate a basic event material according to the target position D1 determined in the event editing stage, generate event information according to the basic event material and the node, and control the virtual role S to move from the current position to the target position D1 according to the event information.

Here, as for the generated basic event material, it can be determined by the user whether to save the basic event material, or the current basic event material is automatically saved when the user triggers a next event editing operation.

Besides, the user can further click the option control B33 to set the movement speed, the action amplitude, the lens movement speed, the action cycle number, and the like of the virtual role S, as actually required, which is not limited in the present disclosure.

With respect to the above S103, event information respectively corresponding to a plurality of nodes might be present in the event stream of a target object, and the event information is generated after the event editing operation is performed on the target object, so that the target object can be controlled to execute the event action corresponding to the event information.

Here, the node includes: a time node and an event node. The target object is controlled according to different nodes to execute a corresponding event action in the virtual three-dimensional scene, which at least includes at least one of the following M1 and M2:
M1: regarding a time node, determining an event execution time on a time axis, and based on the event execution time, generating a time node corresponding to the event execution time.

Illustratively, when a user triggers an event editing operation, a time axis corresponding to a target object can be added to a virtual three-dimensional scene. A cursor on the time axis can be dragged to add a time node at any moment of the time axis, and event editing can be started at said any moment. When performing a special effect preview on the target object after completing the event editing, a basic event material can be generated from an initial time of the time axis, until completion of executing the basic event material included in the event information corresponding to a last time node.

Further, in one embodiment provided by the present disclosure, with respect to each time node in the event stream, the target object is controlled to execute an event action corresponding to the time node in the virtual three-dimensional scene. In response to not reaching a next time node corresponding to the time node after completion of executing the event action corresponding to the time node, an event action corresponding to the time node is repeatedly executed.

Illustratively, in an example where a target object is a virtual role, when there are a plurality of time nodes with respect to the virtual role, an event stream can be generated in an order according to event information corresponding to the plurality of time nodes. For example, the event stream of the virtual role includes event information respectively corresponding to three time nodes, namely, an event A corresponding to a “waving” animation made by the virtual role, and an event B that the virtual role “moves from a point D1 to a point D2”, and an event C corresponding to a “smiling” animation of the virtual role. Herein, an event stream is generated for the three events according to a node order of the event A, the event B and the event C, wherein the time node of the event A is the 0th second on the time axis, and the event execution time is 1 second; the time node of the event B is the 3rd second on the time axis, and the event execution time is 2 seconds; the time node of the event C is the 5th second, and the event execution time is 1 second. At this time, when the special effect preview stage is entered, the virtual role is controlled to execute corresponding event actions according to the order of each time node on the time axis. For example, the virtual role is controlled at the start to execute an event A to make a waving action, and the waving action is repeatedly executed for 3 times according to the event execution time of the event A and the time node of a next event B, and then the event B starts to be executed to control the virtual role to move from a point D1 to a point D2. Here, the event action of movement only needs to be made once according to the event execution time of the event B and the time node of a next event C. If multiple times of movements are needed, then the movement can stop when it arrives at the point D2 for the first time, keep the moving action, and wait for the time node of the event C. Alternatively, the movement can stop when the it arrives at the point D2 for the first time to wait for the time node of the event C. Alternatively, when similar circumstances occur, where a next event has not been triggered upon moving to the target position, as detected by some detection means, a prompt information pops up to remind the user to make an adjustment herein, or an automatic adjustment is made, with a consideration that a phenomenon of an unsmooth action occurs at that time.

In another conceivable embodiment, if a user wants to realize an event action of “waving while moving”, event information corresponding to two or more time nodes need to be overlapped on a time axis. For example, the event stream of the virtual role includes event information respectively corresponding to two time nodes, that is, an event A corresponding to a “waving” animation made by the virtual role, and an event B that the virtual role “moves from a point D1 to a point D2”, which can cause the two events to overlap on the time axis, that is to say, the time node of the event B is inserted into the interval of the event execution time of the event A. Here, the event A and the event B can be strictly synchronized. For example, the event A and the event B have the same time nodes, as well as the same event execution time. In this way, an effect of “waving while moving” can be obtained, wherein waving starts when starting moving and waving stops when stopping moving. It is also possible to execute the actions in a staggered way. For example, the time node of the event A is the 0th second on the time axis, and the event execution time is 3 seconds; the time node of the event B is the 1st second on the time axis, and the event execution time is 2 seconds. In this way, such an effect is obtained that after waving for one second at one site, a virtual role moves to a next site while waving, and after reaching the next site, the virtual role stops waving.

M2: regarding an event node, with respect to each event node in the event stream, controlling the target object to execute an event action corresponding to the event node in the virtual three-dimensional scene, and after completion of executing the event action corresponding to the event node, executing an event action corresponding to a next event node.

Illustratively, the event node only determines the order with respect to other event nodes. Starting from a first event of the event axis, for example, one event stream executes event A, event B, and event C in accordance with the order of the event nodes, and the user can change the event actions executed by the target object by adjusting positions of the event node with respect to other event nodes in the event stream. For example, in an example where the target object is a virtual role, the event A is a “waving” animation; the event B is a “clapping” animation; the event C is a “bowing” animation. In accordance with the event stream prior to adjustment, the virtual role executes the event actions of waving first, then clapping, and bowing at last. Now, the user adjusts the event B to precede the event A so as to obtain the adjusted event stream of event B, event A, and event C. At this time, the virtual role executes the event actions of clapping first, then waving, and bowing at last in accordance with the adjusted event stream.

Here, it is also possible to divide the event stream into a plurality of event axes in accordance with the event types, and simultaneously execute the event actions on the plurality of event axes.

In one embodiment provided by the present disclosure, the target object includes a plurality of target objects. Based on the event execution time of a plurality of nodes of the event streams respectively associated with a plurality of target objects, a merging operation is performed on the event information in the event streams respectively associated with the plurality of target objects to obtain an event execution script. Based on the event execution script, the plurality of target objects are controlled to execute event actions respectively corresponding to the plurality of target objects in the virtual three-dimensional scene.

Illustratively, in the virtual three-dimensional scene, a plurality of target objects can be added. For example, in the virtual three-dimensional scene, a target object A1 corresponding to a virtual character, a target object A2 corresponding to a virtual pet which follows the virtual character to fly, a target object A3 corresponding to a virtual light source which follows the motion of the virtual character to generate a special effect of “stage light”, a target object A4 corresponding to a virtual stage, and a target object A5 corresponding to a virtual camera which follows and shoots the motion of the virtual character are added. An event editing operation is independently performed on these target objects respectively to generate corresponding event streams, and a merging operation is performed on these event streams on a general time axis to obtain an event execution script.

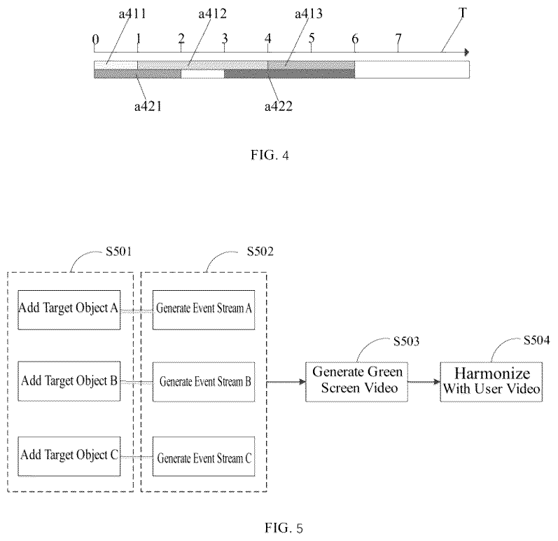

Illustratively, a target object A41 and a target object A42 are placed in a virtual three-dimensional scene. An event stream of the target object A41 includes event information a411, event information a412 and event information a413, and an event stream of the target object A42 includes event information a421 and event information a422. When the merging operation is performed on the event stream of the target object a41 and the event stream of the target object a42, the merging can be performed according to the time nodes and the event execution times included in the event information in the respective event streams. Referring to FIG. 4, which shows an example diagram of performing a merging operation on a general time axis. In FIG. 4, a time node of the event information a411 is the 0th second, and an event execution time is 1 second; the time node of the event information a412 is the 1st second, and the event execution time is 3 seconds; the time node of the event information a413 is the 4th second, and the event execution time is 2 seconds; the time node of the event information a421 is the 0th second, and the event execution time is 2 seconds; the time node of the event information a422 is the 3rd second, and the event execution time is 3 seconds. According to the time nodes and the event execution times included in the event information in the respective event streams, an event execution order is obtained on the general time axis T as follows: [(a411, a421), a412, a422, a413], where (a411, a421) is represented as performing simultaneously.

Here, the event execution order of the event execution script can be changed by adjusting the time nodes and the event execution times in the event information. Details are determined according to the actual situation, and are not limited in the present disclosure.

Besides, when the target object is controlled to execute the event actions, a first target video of the target object is acquired.

In one embodiment provided by the present disclosure, a second target video of a real scene is acquired. A fusion process is performed on the first target video and the second target video to obtain a target video including the target object and the real scene.

Illustratively, a target special effect is generated according to content in a first target video and added to a target application. A user can select to add the target special effect before shooting a real scene through a shooting function of the target application. At this time, a target special effect composed of a virtual role, a virtual article, and a virtual special effect and the like included in the first target video is generated in a shooting picture, and a real scene captured by a camera of a user terminal device is generated outside these areas of the target special effect. When the user starts recording, the first target video is synchronously played, and the virtual role, the virtual article and the virtual special effect in the first target video start to execute event actions in accordance with an event execution script, namely the target special effect. The user can make a corresponding harmonizing action according to the target special effect to obtain the target video.

In another example, the second target video includes a video that has been shot by the user, and a fusion process can be performed according to the target special effect presented in the first target video and the real scene in the second target video, for example, to adjust multiplied speed, model size, model position, and the like of the first and/or the second target video. The adjustment can be a user's manual adjustment, or an adjustment of sizes and relative positions of the model and the target harmonizing object through a preset algorithm to finally obtain the target video, wherein the position of each model in the first target video, as well as the target harmonizing object in the second target video harmonizing with the model, are identified through a neural network algorithm.

In addition, referring to FIG. 5, the present disclosure further provides a flow diagram of another video generation method, including steps S501 to S505.

Step S501, adding a target object.

A target object A, a target object B and a target object C are added to the virtual three-dimensional scene. The target object can include a virtual character, a virtual animal, a virtual article and the like.

Step S502, generating an event stream.

An event adding button in the virtual three-dimensional scene is clicked to select, from the popped event types, a movement event, an animation event, a light and shadow special effect event and a camera movement special effect event to be added, and generate an event stream. A generated with respect to a target object A, an event stream B generated with respect to a target object B and an event stream C generated with respect to a target object C, wherein each event stream can include a plurality of event information.

Step S503, generating a green screen video.

A merging process is performed on the event stream A, the event stream B and the event stream C to obtain a green screen video, namely a first target video, wherein a green screen area is an area other than an area occupied by a target object in the virtual three-dimensional scene.

Step S504, harmonizing with a user video.

A harmonizing process is performed on the user video and the green screen video. A target object in the green screen video appears on the user video, and the green screen area is filled with the content of the user video.

Here, the light and shadow special effect determines whether or not the user video can be overlapped with an area where the light and shadow special effect acts is determined according to the transparency of the light and shadow thereof, and a lower transparency indicates that the content in the user video is more difficult to be presented on the area where the light and shadow special effect acts.

It will be understood by those skilled in the art that in the above method of the particular embodiment, the order of the respective steps as written does not mean that the implementation is limited to a strict execution order, and the specific execution order of the respective steps should be determined by their functions and possible inherent logic.

Based on the same inventive concept, a video generation apparatus corresponding to the video generation method is also provided in the embodiment of the present disclosure. Since the principle of solving the problem by the apparatus in the embodiment of the present disclosure is similar to that of the above-mentioned video generation method in the embodiment of the present disclosure, the implementation of the apparatus can refer to the implementation of the method, and repeated parts are not described again.

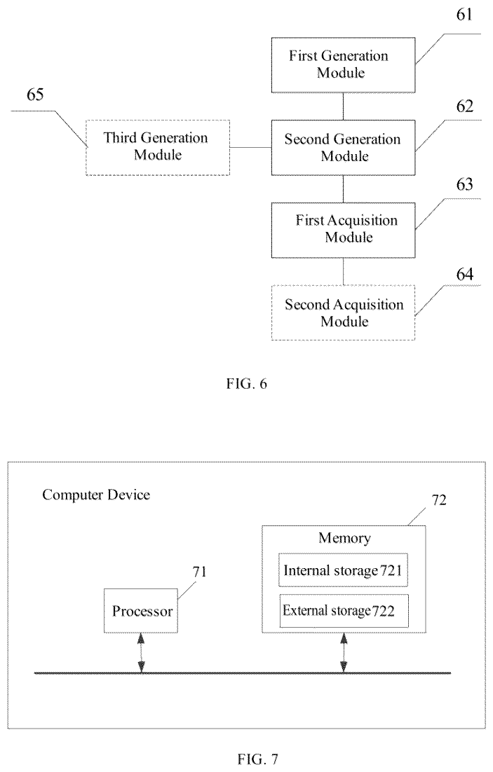

Referring to FIG. 6, which shows a schematic diagram of a video generation apparatus provided by the embodiment of the present disclosure. The apparatus comprises: a first generation module 61, a second generation module 62, a first acquisition module 63; wherein,

The embodiment of the present disclosure further provides a video generation apparatus, comprising:
a first generation module 61 for generating a virtual three-dimensional scene, the virtual three-dimensional scene including at least one target object;
a second generation module 62 for generating, in response to performing an event editing operation on the target object, an event stream corresponding to the target object, the event stream including event information respectively corresponding to a plurality of nodes, wherein the event information is determined based on the event editing operation and is used for describing an event action executed by the target object;
a first acquisition module 63 for controlling the target object to execute an event action corresponding to the event information in the virtual three-dimensional scene based on the event information respectively corresponding to the plurality of nodes in the event stream, and acquiring a first target video of the target object when controlling the target object to execute the event action.

In an optional implementation, the apparatus further comprises a second acquisition module 64 for:
acquiring a second target video of a real scene;
performing a fusion process on the first target video and the second target video to obtain a target video including the target object and the real scene.

In an optional implementation, the first generation module 61 is further used for:
generating a virtual three-dimensional space corresponding to the virtual three-dimensional scene;
determining a coordinate value of at least one target object in the virtual three-dimensional space;
adding a three-dimensional model corresponding to the target object into the virtual three-dimensional space to form the virtual three-dimensional scene based on the coordinate value of the target object in the virtual three-dimensional space.

In an optional implementation, the apparatus further comprises a third generation module 65 for:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

In an optional implementation, when an editing operation is performed on the target object, the second generation module 62 is further used for:
generating the node, and receiving a basic event material corresponding to the generated node;
based on the basic event material, generating event information corresponding to the generated node.

In an optional implementation, the second generation module 62 is further used for:
determining an event execution time on a time axis, and based on the event execution time, generating a time node corresponding to the event execution time.

In an optional implementation, when the target object is controlled to execute a corresponding event action in the virtual three-dimensional scene based on the event stream, the second generation module 62 is used for:
with respect to each time node in the event stream, controlling the target object to execute an event action corresponding to the time node in the virtual three-dimensional scene;
in response to not reaching a next time node corresponding to the time node after completion of executing the event action corresponding to the time node, repeatedly executing an event action corresponding to the time node.

In an optional implementation, when the target object is controlled to execute the corresponding event action in the virtual three-dimensional scene based on the event stream, the second generation module 62 is further used for:
with respect to each event node in the event stream, controlling the target object to execute an event action corresponding to the event node in the virtual three-dimensional scene, and after completion of executing the event action corresponding to the event node, executing an event action corresponding to a next event node.

In an optional implementation, when the target object is controlled to execute an event action corresponding to the event information in the virtual three-dimensional scene based on the event information respectively corresponding to a plurality of nodes in the event stream, the second generation module 62 is used for:
based on an event execution time of a plurality of nodes of the event stream respectively associated with a plurality of target objects, performing a merging operation on event information in the event stream respectively associated with the plurality of target objects to obtain an event execution script;
based on the event execution script, controlling the plurality of target objects to execute event actions respectively corresponding to the plurality of target objects in the virtual three-dimensional scene.

The description of the processing flow of respective modules in the apparatus and the interaction flow among the respective modules refer to the relevant description in the above method embodiments, and will not be described in detail here.

An embodiment of the present disclosure further provides a computer device as shown in FIG. 7, which is a schematic structural diagram of a computer device provided by the embodiment of the present disclosure. The computer device comprises:
a processor 71 and a memory 72, wherein the memory 72 stores machine readable instructions executable by the processor 71, and the processor 71 is used for executing the machine readable instructions stored in the memory 72; when the machine readable instructions are executed by the processor 71, the processor 71 executes the following steps:
generating a virtual three-dimensional scene, the virtual three-dimensional scene including at least one target object;
generating, in response to performing an event editing operation on the target object, an event stream corresponding to the target object, the event stream including: event information respectively corresponding to a plurality of nodes, wherein the event information is determined based on the event editing operation and is used for describing an event action executed by the target object;
controlling the target object to execute an event action corresponding to the event information in the virtual three-dimensional scene based on the event information respectively corresponding to the plurality of nodes in the event stream, and acquiring a first target video of the target object when controlling the target object to execute the event action.

The above-mentioned memory 72 includes an internal storage 721 and an external storage 722. The internal storage 721 here is also referred to as an internal memory for temporarily storing operational data in the processor 71 and data exchanged with an external storage 722 such as a hard disk. The processor 71 exchanges data with the external storage 722 through the internal storage 721. For the specific execution process of the above-mentioned instruction, reference can be made to the steps of the video generation method according to the embodiment of the present disclosure, and details are not described here again.

The embodiment of the present disclosure further provides a computer readable storage medium, on which a computer program is stored, the computer program, when performed by a processor, executing the steps of the video generation method according to the above-mentioned method embodiment. The storage medium can be a transitory or non-transitory computer readable storage medium.

The embodiment of the present disclosure further provides a computer program product carrying program code, and instructions included in the program code can be used for executing the steps of the video generating method according to the above-mentioned method embodiments. Details can be obtained by referring to the above-mentioned method embodiments and are not described herein again.

The above-mentioned computer program product can be specifically implemented by means of hardware, software or a combination thereof. In an optional embodiment, the computer program product is embodied as a computer storage medium. In another alternative embodiment, the computer program product is specifically embodied as a Software product, such as a Software Development Kit (SDK) or the like.

It can be clearly understood by those skilled in the art that, for convenience and simplicity of description, the specific working process of the system and the apparatus described above can obtained by referring to the corresponding process in the foregoing method embodiments, and details are not described herein again. In the several embodiments provided by the present disclosure, it should be understood that the disclosed system, apparatus and method can be implemented in other ways. The above-described apparatus embodiments are merely illustrative. For example, the division of the units is only division of logical functions, and in actual implementation, there are additional division ways. For another example, multiple units or components can be combined or integrated into another system, or some features can be omitted or not implemented. Additionally, the mutual coupling, direct coupling or communication connection shown or discussed can be implemented by indirect coupling or communication connection through some communication interfaces, apparatuses or units, which can be in an electrical, mechanical or other form.

The units described as separate parts may or may not be physically separate, and parts displayed as units may or may not be physical units, that is, they can be located in one place or distributed on multiple network units. Some or all of the units can be selected according to actual needs to achieve the purpose of the solution of the embodiment.

In addition, respective functional units in the respective embodiments of the present disclosure can be integrated into one processing unit, or respective units can physically exist alone, or two or more units can be integrated into one unit.

The functions, if implemented in the form of software functional units and sold or used as a stand-alone product, can be stored in a non-transitory computer readable storage medium executable by a processor. Based on such understanding, a part of the technical solution of the present disclosure essential or making contribution to the related art, or a part of the technical solution, can be embodied in form of a software product. The computer software product is stored in a storage medium and includes several instructions for causing a computer device (which can be a personal computer, a server, a network device, or the like) to execute all or part of the steps of the method according to the respective embodiments of the present disclosure. The foregoing storage medium includes: a U-disk, a removable hard disk, a Read-Only Memory (ROM), a Random Access Memory (RAM), a magnetic disk, an optical disk, or other various media capable of storing program codes.

Finally, it should be noted that, the above-mentioned embodiments are merely specific embodiments of the present disclosure, which are used to illustrate the technical solutions of the present disclosure, but not to limit the technical solutions, and the protection scope of the present disclosure is not limited thereto. Although the present disclosure is described in detail with reference to the foregoing embodiments, those skilled in the art should understand that, any of those skilled in the art can still make modifications or easily conceive of changes to the technical solutions disclosed in the foregoing embodiments, or make equivalent substitutions for part of the technical features therein. Such modifications, changes or substitutions will not cause the essence of the corresponding technical solution to depart from the spirit and scope of the technical solutions of the embodiments of the present disclosure, and they should be included in the protection scope of the present disclosure. Therefore, the protection scope of the present disclosure shall be subject to the protection scope of the claims.

What is claimed is:

1. A video generation method, comprising:
generating a virtual three-dimensional scene, the virtual three-dimensional scene including at least one target object;
in response to performing an event editing operation on the target object, generating an event stream corresponding to the target object, the event stream including: event information respectively corresponding to a plurality of nodes, wherein the event information is determined based on the event editing operation and is used for describing an event action executed by the target object;
controlling the target object to execute an event action corresponding to the event information in the virtual three-dimensional scene based on the event information respectively corresponding to the plurality of nodes in the event stream, and acquiring a first target video of the target object when controlling the target object to execute the event action.

2. The method according to claim 1, wherein the method further comprises:
acquiring a second target video of a real scene;
performing a fusion process for the first target video and the second target video to obtain a target video including the target object and the real scene.

3. The method according to claim 1, wherein the generating a virtual three-dimensional scene comprises:
generating a virtual three-dimensional space corresponding to the virtual three-dimensional scene;
determining a coordinate value of at least one target object in the virtual three-dimensional space;
based on the coordinate value of the target object in the virtual three-dimensional space, adding a three-dimensional model corresponding to the target object into the virtual three-dimensional space to form the virtual three-dimensional scene.

4. The method according to claim 1, wherein the method further comprises:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

5. The method according to claim 1, wherein the performing an event editing operation on the target object comprises:
generating the node, and receiving a basic event material corresponding to the generated node;
based on the basic event material, generating event information corresponding to the generated node.

6. The method according to claim 5, wherein the node includes a time node, and the generating the node comprises:
determining an event execution time on a time axis, and based on the event execution time, generating a time node corresponding to the event execution time.

7. The method according to claim 6, wherein the controlling the target object to execute an event action corresponding to the event information in the virtual three-dimensional scene based on the event information respectively corresponding to the plurality of nodes in the event stream comprises:
with respect to each time node in the event stream, controlling the target object to execute an event action corresponding to the time node in the virtual three-dimensional scene;
in response to not reaching a next time node corresponding to the time node after completion of executing the event action corresponding to the time node, repeatedly executing the event action corresponding to the time node.

8. The method according to claim 5, wherein the node includes an event node, and the controlling the target object to execute an event action corresponding to the event information in the virtual three-dimensional scene based on the event information respectively corresponding to the plurality of nodes in the event stream comprises:
with respect to each event node in the event stream, controlling the target object to execute an event action corresponding to the event node in the virtual three-dimensional scene, and after completion of executing the event action corresponding to the event node, executing an event action corresponding to a next event node.

9. The method according to claim 1, wherein the target object includes a plurality of target objects, and the controlling the target object to execute an event action corresponding to the event information in the virtual three-dimensional scene based on the event information respectively corresponding to the plurality of nodes in the event stream comprises:
based on an event execution time of a plurality of nodes of the event streams respectively associated with a plurality of target objects, performing a merging operation on event information in the event streams respectively associated with the plurality of target objects to obtain an event execution script;
based on the event execution script, controlling the plurality of target objects to execute event actions respectively corresponding to the plurality of target objects in the virtual three-dimensional scene.

10. A computer device, comprising: a processor, and a memory having machine readable instructions executable by the processor stored thereon, wherein the processor is used for executing the machine readable instructions stored in the memory; and when the machine readable instructions are executed by the processor, the processor executes the steps of the video generation method according to claim 1.

11. The computer device according to claim 10, wherein the processor further executes the steps of:
acquiring a second target video of a real scene;
performing a fusion process for the first target video and the second target video to obtain a target video including the target object and the real scene.

12. The computer device according to claim 10, wherein the generating a virtual three-dimensional scene comprises:
generating a virtual three-dimensional space corresponding to the virtual three-dimensional scene;
determining a coordinate value of at least one target object in the virtual three-dimensional space;
based on the coordinate value of the target object in the virtual three-dimensional space, adding a three-dimensional model corresponding to the target object into the virtual three-dimensional space to form the virtual three-dimensional scene.

13. The computer device according to claim 10, wherein the processor further executes the steps of:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

14. The computer device according to claim 10, wherein the performing an event editing operation on the target object comprises:
generating the node, and receiving a basic event material corresponding to the generated node;
based on the basic event material, generating event information corresponding to the generated node.

15. The computer device according to claim 14, wherein the node includes a time node, and the generating the node comprises:
determining an event execution time on a time axis, and based on the event execution time, generating a time node corresponding to the event execution time.

16. A non-transitory computer readable storage medium, wherein the computer readable storage medium has a computer program stored thereon, and when the computer program is performed by a computer device, the computer device executes the steps of the video generation method according to claim 1.

17. The non-transitory computer readable storage medium according to claim 16, wherein the computer device further executes the steps of:
acquiring a second target video of a real scene;
performing a fusion process for the first target video and the second target video to obtain a target video including the target object and the real scene.

18. The non-transitory computer readable storage medium according to claim 16, wherein the generating a virtual three-dimensional scene comprises:
generating a virtual three-dimensional space corresponding to the virtual three-dimensional scene;
determining a coordinate value of at least one target object in the virtual three-dimensional space;
based on the coordinate value of the target object in the virtual three-dimensional space, adding a three-dimensional model corresponding to the target object into the virtual three-dimensional space to form the virtual three-dimensional scene.

19. The non-transitory computer readable storage medium according to claim 16, wherein the computer device further executes the steps of:
in response to an adding operation of adding the target object into the virtual three-dimensional scene, determining an initial feature of the target object in the virtual three-dimensional scene, the initial feature including at least one of: an initial pose, an initial animation, an initial light and shadow type, and an initial lens view angle;
based on the initial feature, adding a three-dimensional model corresponding to the target object into the virtual three-dimensional scene.

20. The non-transitory computer readable storage medium according to claim 16, wherein the performing an event editing operation on the target object comprises:
generating the node, and receiving a basic event material corresponding to the generated node;
based on the basic event material, generating event information corresponding to the generated node.
